(19) United States
(12) Patent Application Publication
(10) Pub. No.: US 2006/0265883 A1
(43) Pub. Date: Nov. 30, 2006

(54) Multi-purpose knife device

(76) Inventor: Brett Di Paolo, Brampton (CA)

Correspondence Address: GEORGE A. ROLSTON, 45 SHEPPARD AVE EAST, SUITE 900, TORONTO, ON, M2N5W9, CA

(21) Appl. No.: 11/411,148

(22) Filed: Apr. 26, 2006

Related U.S. Application Data
(60) Provisional application No. 60/674,694, filed on Apr. 26, 2005.

(51) Int. Cl. B26B 29/00

(52) U.S. Cl. 30/295

(57) ABSTRACT

A multi-purpose knife device having an elongate handle member and a knife portion, wherein the knife portion having a tang portion, a food manipulation portion and a blade portion, the tang portion being provided at a proximal end of the knife portion for coupling the elongate handle member to the knife portion, the food manipulation portion being provided at a distal end of the knife portion, and the blade portion being provided between the proximate end and the distal end of the knife portion, wherein the blade portion having a serrated edge and a sharp edge. The serrated edge and the sharp edge are formed along a bottom surface of the knife portion. The food manipulation portion extends generally above a top surface of the distal end of the knife portion.

### FIELD OF THE INVENTION

The invention relates to cooking utensils, and more particularly to a multi-purpose knife device.

### PRIOR APPLICATION

This application claims the benefit of U.S. Provisional Application Ser. No. 60/674,694, filed Apr. 26, 2005, entitled KNIFE DEVICE.

### BACKGROUND OF THE INVENTION

Outdoor barbequing is an increasingly popular cooking technique which produces foods, such as steaks, chicken and vegetables, having unique flavors and textures which cannot be easily duplicated in a traditional kitchen. During the preparation of a meal which involves the searing and grilling of food on a barbeque, the barbeque user often must use several cooking utensils to tenderize, turn and reposition the food on the barbeque grill. In order to determine whether the food is satisfactorily cooked, the barbeque user commonly must slice the food using a knife to inspect the food. To perform each of these tasks, most barbeque users have at least a half dozen individual cooking utensils that they regularly use when barbequing. Given that there is limited space on barbeques to store these utensils, it often occurs that the barbeque user must step away from the barbeque to locate the appropriate utensil(s) for each of these purposes. During which time the foods may become adhered to the grill and/or burn as a result of the intense flame of the barbeque. Moreover, the use of individual cooking utensils may result in the barbeque user accidentally burning their hand, wrist or arm on the barbeque when searching for the appropriate utensil. Dropping one or more of these individual utensils may also result in considerable damage to the cooking surface of the barbeque grills and the heating element within the barbeque.

Accordingly, there is a need for a multi-purpose knife device for use when barbequing that enables a barbeque user to tenderize, turn, slice and reposition a food on a barbeque grill. There is a further need for a multi-purpose knife device having an elongate handle member that maintains the barbeque user's hands and wrists at a safe distance form the grill when barbequing.

### SUMMARY OF THE INVENTION

The present invention is directed to a multi-purpose knife device including an elongate handle member and a knife portion, the knife portion having a tang portion, a food manipulation portion and a blade portion, the tang portion being provided at a proximal end of the knife portion for coupling the elongate handle member to the knife portion, the food manipulation portion being provided at a distal end of the knife portion, and the blade portion being provided between the proximate end and the distal end of the knife portion, wherein the blade portion having a serrated edge and a sharp edge. The knife portion has a top surface and a bottom surface, wherein the serrated edge and the sharp edge are formed along the bottom surface. The food manipulation portion extends generally above the top surface of the distal end of the knife portion. The food manipulation portion having a substantially curved hook portion that terminates at a sharpened point. The substantially curved hook portion is formed with a cutting edge. The serrated edge constitutes generally 50% to 60% of the bottom surface of the knife portion. The sharpened edge constitutes generally 40% to 50% of the bottom surface of the knife portion. The serrated edge has a plurality of teeth extending from the bottom surface of the knife portion. The elongate handle member may have a heat-resistant sleeve and a hanging means. The elongate handle member and the knife portion may be made of a metallic material.

The present invention is further directed to a multi-purpose knife device including an elongate handle member and a knife portion coupled to the elongate handle member, the knife portion having a top surface and a bottom surface, wherein the top surface is provided with a food manipulation portion having a substantially curved hook portion that terminates at a sharpened point, and wherein the bottom surface is provided with a blade portion having a serrated edge and a sharp edge. The substantially curved hook portion may be formed with a cutting edge. The serrated edge constitutes generally 50% to 60% of the bottom surface of the knife portion. The sharpened edge constitutes generally 40% to 50% of the bottom surface of the knife portion.

### BRIEF DESCRIPTION OF THE DRAWINGS

For a better understanding of the present invention, and to show more clearly how it may be carried into effect, reference will now be made, by way of example, to the accompanying drawings, in which:

FIG. 1 is a perspective view of a multi-purpose knife device made in accordance with a preferred embodiment of the invention;

FIG. 2 is a side elevation view of the multi-purpose knife device of FIG. 1; and

FIG. 3 is an explode view of the multi-purpose knife device of FIG. 1.

### DETAILED DESCRIPTION OF THE INVENTION

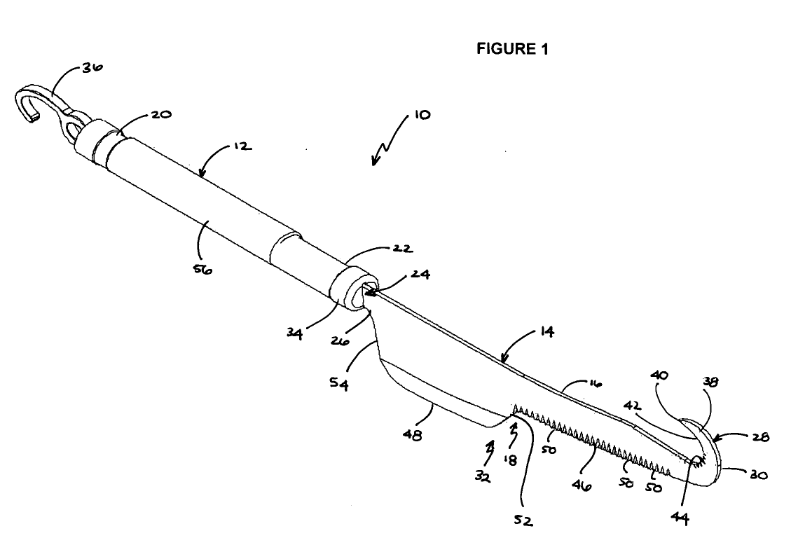

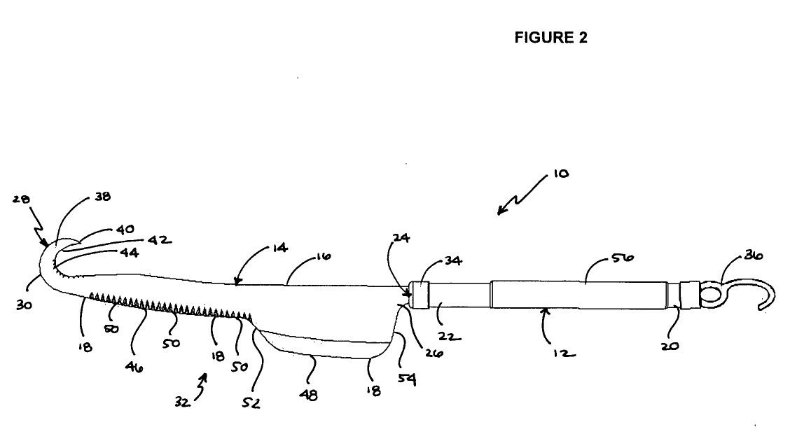

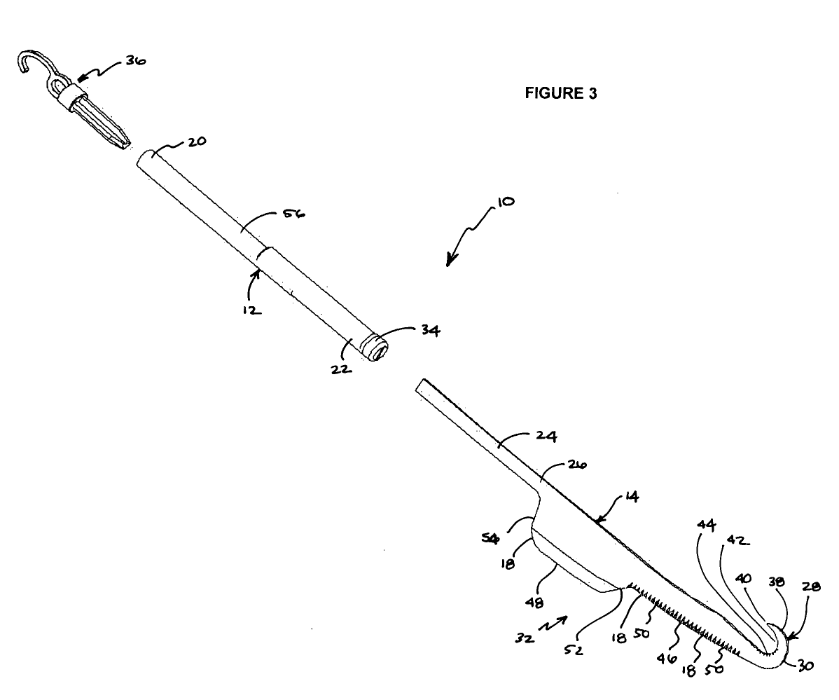

Reference is made to FIGS. 1, 2, and 3 which illustrate a multi-purpose knife device 10 for use when cooking food made in accordance with a preferred embodiment of the present invention. Knife device 10 has an elongate handle member 12 and a knife portion 14 having a flat, top surface 16 and a bottom surface 18. The elongate handle member 12 has a first end 20 and an opposite second end 22. The knife portion 14 has a tang portion 24 provided at a proximal end 26 thereof, a food manipulation portion 28 provided at a distal end 30 of the blade portion 14, and a blade portion 32 extending generally along the bottom surface 18 between the proximal end 26 and the distal end 30 of the knife portion 14. The tang portion 24 is adapted to be received and fixedly secured within a sleeve 34 provided on the second end 22 of the elongate handle member 12. The securement of the tang portion 24 of the knife portion 14 to the sleeve 34 of the elongate handle means 12 may be accomplished by any suitable method, such as, for example, welding or rivets. The first end 20 of the elongate handle member 12 may have an optional hanging means 36 to allow the knife device 10 to be attached to a barbeque or the barbeque user's belt.

The food manipulation portion 28 has a substantially curved hook portion 38 that extends generally above and from the top surface of the distal end 30 of the knife portion 14. The curved hook portion 36 tapers and terminates at a sharpened point 40 which the barbeque user may utilize tenderize, turn or reposition food when cooking on a barbeque grill. The dimensions of the hook portion 38 and the sharpened point 40 are tapered to facilitate the penetration of the surface of the food. By this design, the sharpened point 40 of the hook portion 38 may be used by the barbeque user to puncture holes in the surface of foods, such as sausages and wieners, so as to allow the juices to escape and the seasonings to permeate the food. Additionally, the sharpened point 40 of the hook portion 38 is adapted to enable the barbeque user to use the multi-purpose knife device 10 to engage, drag and flip various foods on the grill of the barbeque, for example. For foods that have been marinated in a sauce or dressing, the tapered dimensions of the hook portion 38 minimizes the disturbance of the marinade or sauce when repositioning the food on the barbeque grill as compared with a spatula or tongs. In a further embodiment of the present invention, an inner surface 42 of the hook portion 38 may be provided with a cutting edge 44 for slicing food on the barbeque and to securely engage food on the sharpened point 40, thereby reducing the likelihood that the food will become disengaged from the sharpened point 40 when being repositioned on the barbeque grill.

The blade portion 32 is provided with a serrated edge 46 and a sharp edge 48 that extend along the bottom surface 18 of the knife portion 14. The serrated edge 46 has a plurality of sharp teeth 50 that extend from the bottom surface 18 between the distal end 30 and a mid-section 52 of the blade portion 32. The teeth 50 are generally triangular-shaped and are adapted to pierce and slice the food. It should be understood that the teeth 50 may have any suitable shape and dimension as is known by persons skilled in the art. The serrated edge 46 is designed to enable the barbeque user to coarsely slice and cut the foods on the barbeque.

The sharp edge 48 extends along the bottom surface 18 from the mid-portion 52 to a base portion 54 of the blade portion 32. The sharp edge 48 is honed and sharpened to facilitate the fine slicing and cutting of food cooking on a barbeque for example. In a preferred embodiment of the present invention, the sharp edge 48 extends a greater distance from the bottom surface 18 of the knife portion 14 than the serrated edge 46. By this design, the sharp edge 48 is pronounced from the bottom surface 18 of the blade portion 32 and may be utilized by the barbeque user to cleave or chop the food without interference from the serrated edge 46.

In an embodiment of the present invention, the serrated edge 46 constitutes generally 50% to 60% of the bottom surface 18 of the knife portion 14. The sharp edge 48 constitutes generally 40% to 50% of the bottom surface 18 of the knife portion 14, depending upon the dimensions of the serrated edge 46. By this design, the serrated edge 46 and the sharp edge 48 are sized to enable the user to slice and chop a variety of foods, including meats, vegetables and fruit. For example, the serrated edge 46 of the blade portion 32 may be used by the barbeque user to slice off a portion of the food for sampling purposes and/or to ascertain whether the food has been properly cooked.

In a further embodiment of the present invention, the first end 20 of the elongate handle member 12 may be provided with a heat-resistant sleeve 56 to minimize the transmission of heat from the multi-purpose knife device 10 to the hand of the barbeque user. The heat-resistant sleeve 56 may be made of any suitable material, such as, for example, rubber or polypropylene. It should be understood that the elongate handle member 12 and the knife portion 14 may be manufactured from any suitable material known by persons skilled in the art. For example, the elongate handle member 12 and the knife portion 14 may be manufactured from a metallic material, such as stainless steel or any steel material that may be appropriately formed and used to tenderize, turn, slice and reposition food when cooking on a barbeque grill. It should be understood that the length of the elongate handle member 12 should be sufficient to ensure that the hands and arms of the barbeque user are a safe distance away from the heated surfaces of the barbeque.

Although the use of the present invention has been described in the context of a barbeque user cooking foods on a barbeque, it should be understand that knife device 10 may be utilized in various cooking environments. For example, the knife device 10 may be utilized in a traditional kitchen to prepare various foods for cooking or to tenderize, turn, slice and/or reposition foods baking within an oven.

The present invention has been described with regard to specific embodiments. However, it will obvious to persons skilled in the art that a number of variants and modifications can be made without departing from the scope and spirit of the invention, the scope of which is defined in the appended claims.

1. A multi-purpose knife device, the knife device comprising:
an elongate handle member; and
a knife portion having a tang portion, a food manipulation portion and a blade portion, the tang portion being provided at a proximal end of the knife portion for coupling the elongate handle member to the knife portion, the food manipulation portion being provided at a distal end of the knife portion, and the blade portion being provided between the proximate end and the distal end of the knife portion, wherein the blade portion having a serrated edge and a sharp edge.

2. The multi-purpose knife device as claimed in claim 1, wherein the knife portion has a top surface and a bottom surface, and wherein the blade portion being formed along the bottom surface.

3. The multi-purpose knife device as claimed in claim 2, wherein the serrated edge constituting generally 50% to 60% of the bottom surface of the knife portion.

4. The multi-purpose knife device as claimed in claim 2, wherein the sharpened edge constituting generally 40% to 50% of the bottom surface of the knife portion.

5. The multi-purpose knife device as claimed in claim 2, wherein the food manipulation portion extending generally above the top surface of the distal end of the knife portion.

6. The multi-purpose knife device as claimed in claim 1, wherein food manipulation portion having a substantially curved hook portion that terminates at a sharpened point.

7. The multi-purpose knife device as claimed in claim 6, wherein the substantially curved hook portion is formed with a cutting edge.

8. The multi-purpose knife device as claimed in claim 2, wherein the serrated edge has a plurality of teeth extending from the bottom surface of the knife portion.

9. The multi-purpose knife device as claimed in claim 1, wherein the elongate handle member has a heat-resistant sleeve.

10. The multi-purpose knife device as claimed in claim 1, wherein the elongate handle member has a hanging means.

11. The multi-purpose knife device as claimed in claim 1, wherein the elongate handle member and the knife portion are made of a metallic material.

12. A multi-purpose knife device, the knife device comprising:
an elongate handle member; and
a knife portion coupled to the elongate handle member, the knife portion having a top surface and a bottom surface, wherein the top surface is provided with a food manipulation portion having a substantially curved hook portion that terminates at a sharpened point, and wherein the bottom surface is provided with a blade portion having a serrated edge and a sharp edge.

13. The multi-purpose knife device as claimed in claim 12, wherein the substantially curved hook portion is formed with a cutting edge.

14. The multi-purpose knife device as claimed in claim 12, wherein the serrated edge constituting generally 50% to 60% of the bottom surface of the knife portion.

15. The multi-purpose knife device as claimed in claim 12, wherein the sharpened edge constituting generally 40% to 50% of the bottom surface of the knife portion.
